(19) United States
(12) Patent Application Publication
(10) Pub. No.: US 2004/0115248 A1
(43) Pub. Date: Jun. 17, 2004

(54) Compositions and methods relating to hydration of non-human animals

(76) Inventors: William F. Fels, Everett, WA (US); Rhonda C. Fels, Everett, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/718,289

(22) Filed: Nov. 19, 2003

(51) Int. Cl. A23K 1/165

(52) U.S. Cl. 424/442

(57) ABSTRACT

Hydration beverages configured for non-human animals. The beverages can comprise surface water or other naturally-obtained water that comprises various trace elements, minerals, vitamins, etc., that are beneficial for animals and that animals have traditionally obtained by drinking such natural water. This compares with highly processed, human-specific water available from the tap or from various human-specific water suppliers, wherein a significant amount (indeed, sometimes substantially all) of the potentially beneficial nutrients and other beneficial components have been removed in order to meet human drinking water safety standards. The beverages comprise one or more animal-specific added flavorants configured to appeal substantially only to non-human animals. The hydration compositions are provided in containers that comprise labeling or packaging that identifies the water as specifically for non-human animals.

### BACKGROUND

In recent years there has been increasing interest in water quality. Accordingly, human tap water and other human potable water have come under strict regulations. Disinfecting chemicals have been added to the water, and Maximum Contaminant Levels (MCL) and super-filtering have been implemented.

In contrast to modern humans, dogs, cats and other ambulatory animals are typically scavengers by nature. Daily hydration, vitamins and minerals are gathered from diverse sources to provide a diet rich in a variety of substances for the support of internal biological systems. As a result of the restrictions applied to human tap water, however, the tap water delivers significantly reduced nutritional benefits to pets and other companion animals (indeed, non-human animals in general). The result may be an animal that has no interest in drinking the water (hydration) other than to assist digestion processes. In addition, the water can lose flavors that animals like. In other words, a significant method by which non-human animals procure nutrients is defeated by processed water for humans.

Thus, there has gone unmet a need for improved compositions, systems, methods and the like to provide hydration systems that are enticing to non-human animals and/or more healthful than tap water. The present compositions, systems and methods, etc., provide one or more of these and other advantages.

### SUMMARY

The present invention comprises waters, or aqueous hydration solutions, that comprise healthful trace nutrients, flavors and the like that are configured for and beneficial to non-human animals. In certain embodiments, the water solutions are based on the theory that open-source surface water as a base contains certain nutrients to provides healthy hydration balance in animals. By formulating an aqueous solution with natural flavors, animals will increase their water uptake. Increased water uptake may alleviate multiple diseases and internal putrefaction. The hydration solutions herein can be packaged and shipped any desired packaging forms and the color and biologically stability of the solutions can remain substantially unchanged for at least one year or more. The packaging can be plastic, glass, or otherwise, and can be resealable and aseptic.

In one aspect, the systems, products, etc., herein comprise hydration systems configured specifically for non-human animals. The systems comprising a sealable, typically resealable, container such as a bottle, water dish, etc., containing a hydration beverage comprising surface water comprising trace elements and nutrients beneficial for non-human animals and at least one of packaging and labeling configured to indicate that the beverage is not for humans, for example wherein the beverage does not meet FDA and EPA human safety standards. The hydration beverage further can comprise at least one added flavorant configured to appeal substantially only to non-human animals and the system can comprise at least one of packaging and labeling configured to identify the flavorant. The added flavorant can be a meat flavoring such as beef, chicken, lamb, turkey or fish, or another flavoring such as an herbivoredirected flavoring such as chlorophyll, grass, lettuce, or other flavorings such as apple cider vinegar and milk lactose.

The surface water can be collected substantially only from at least one of a glacier, snowfield, creek, stream, river, seep, ditch, canal, open reservoir, pond, bay, bayou, swamp, and bog. The surface water can comprise a pH of about 6.3 to 7.1 and further can comprise colloidal minerals and vitamins. The colloidal minerals and vitamins can be at least one of vitamin B12, thiamine, riboflavin, niacin, pyridoxine HCL, pantothenic acid, choline, cholecalciferol, d-alpha tocopheryl acetate, silica, iron, zinc, cobalt, copper, manganese, magnesium, potassium, phosphorus, and carbon. The beverage can be configured to be color stable and bacteriologically stable for at least about one, two, three or more years in a sealed container.

The surface water can be produced by purifying with closed container circulation through low pressure ultraviolet (UV) light in a range from about 19 mJ cm² to 253 mJ cm², for example at about 200 to 300 nanometers. with closed container circulation with ozone (O₃) of about 2.4 0.5 to 2.4 to 25.0 grams or more per U.S. gallon injection, or by heating to about 78° F. to about 212° F.

In some embodiments, the surface water is not spring water or borehole water.

In further embodiments there are hydration beverages configured for non-human animals that comprise water, which may or may not be surface water, and at least one added flavorant such as those discussed elsewhere herein. Typically, the beverage is associated with packaging or labeling configured to specifically identify the flavorant. The added flavorant can comprise about 100 to 15,000 ppm (parts per million) of the composition.

The container can be a resealable container, and wherein the hydration composition consists essentially of surface water comprising trace elements and nutrients beneficial for non-human animals and a label configured to indicate that the beverage is not for humans, wherein the beverage does not meet FDA and EPA human safety standards.

In other embodiments, the hydration system configured for non-human animals, comprises a resealable container containing a hydration beverage comprising surface water purified by one or more of closed container circulation through low pressure ultraviolet (UV) light in a range from about 19 mJ cm² to 253 mJ cm², such as from about 200 to 300 nm, closed container circulation with ozone (O₃) of about 0.5 to 25.0 or more grams per U.S. gallon injection and heating to about 78° F. to about 212° F. Typically, the surface water does not meet FDA or EPA human safety standards, and packaging and labeling attached to the container can be configured to indicate that the beverage is not for humans.

In still further embodiments herein, methods of hydrating a non-human animal comprise a) dispensing a hydration beverage configured for the non-human animal from a resealable container into a drinking vessel configured for drinking by the non-human animal, wherein the hydration beverage can comprise surface water comprising trace elements and nutrients beneficial for the non-human animal, wherein at least one of packaging and labeling for the resealable container can be configured to indicate that the hydration beverage is not for humans, and wherein the hydration beverage does not meet FDA and EPA human safety standards; and, b) allowing the non-human animal to drink from the drinking container. The hydration beverage can comprise at least one added flavorant configured to appeal substantially only to the non-human animal.

In other embodiments, the methods can comprise a) dispensing a hydration composition configured for the non-human animal from a container into a drinking vessel configured for drinking by the non-human animal, the composition comprising water and at least one added flavorant configured to appeal substantially only to the non-human animal, typically wherein at least one of packaging and labeling attached to the container can be configured to specifically identify the flavorant; and, b) allowing the non-human animal to drink from the drinking container. The hydration composition can consist essentially of surface water.

These and other aspects, features and embodiments are set forth within this application, including the following Detailed Description and attached drawings. Unless expressly stated otherwise or clear from the context, all embodiments, aspects, features, etc., can be mixed and matched, combined and permuted in any desired manner. In addition, various references are set forth herein, including in the CrossReference to Related Applications, that discuss certain systems, apparatus, methods and other information; all such references are incorporated herein by reference in their entirety and for all their teachings and disclosures, regardless of where the references may appear in this application.

### BRIEF DESCRIPTION OF THE DRAWINGS

FIG. 1 is a schematic drawing of a hydration system in combination with a food and water dish.

FIG. 2 is a schematic drawing of a plurality of hydration systems in a carton.

### DETAILED DESCRIPTION

The present invention provides hydration beverages configured for non-human animals. In various embodiments, the beverages comprise surface water or other naturally-obtained water that comprises various trace elements, minerals, vitamins, etc., that are beneficial for animals and that animals have traditionally obtained by drinking such natural water. This compares with highly processed, human-specific water available from the tap or from various human-specific water suppliers, wherein a significant amount (indeed, sometimes substantially all) of the “good stuff” (e.g., potentially beneficial nutrients) has been removed in order to meet human drinking water safety standards, such as FDA and/or EPA standards, which in one embodiment is The Safe Water Drinking Act, 40 C.F.R. In some embodiments, the beverages comprise one or more animal-specific added flavorants configured to appeal substantially only to non-human animals. The hydration compositions are provided in containers that comprise labeling or packaging that identifies the water as specifically for non-human animals, and typically also identifies the water as not meeting FDA and EPA human safety standards, and can identify the at least one added flavorant.

Such beverages provide the animals with trace elements and nutrients that the animals could not otherwise obtain through tap water, while simultaneously providing the animals with portable beverages that are treated to protect the animals from bacteria, fungi and other microorganisms that may be found in surface water that has not been purified or treated in any manner.

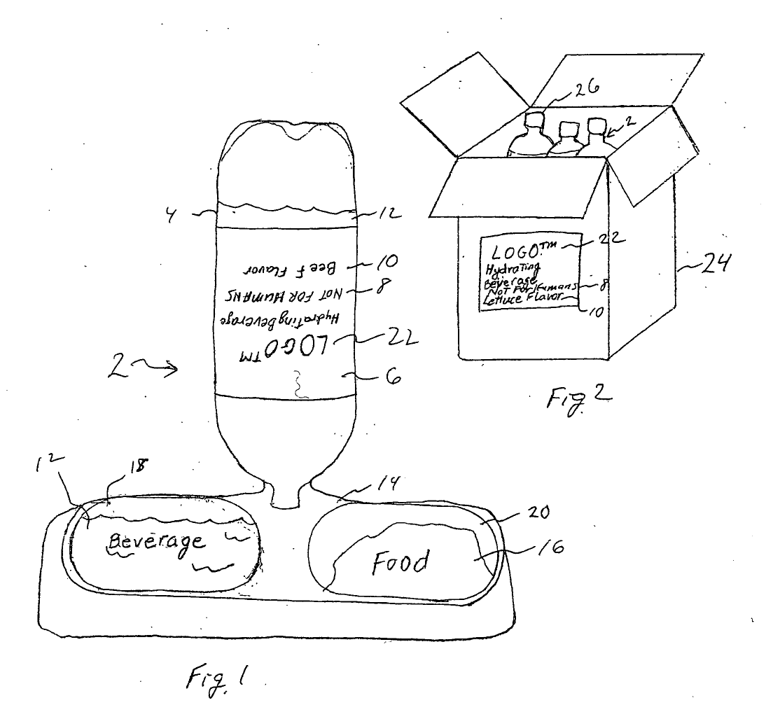

Turning to the figures, FIG. 1 depicts a hydration system 2 configured for non-human animals comprising a sealable container 4 comprising labeling 6 and containing a hydrating beverage 12. The hydration system 2 is operably connected to a food and water dish 14 comprising a first, beverage holding area that is operably connected to container 4, and a second, food holding area 20 containing food 16. In the embodiment shown, the hydration system 2 is threaded into an opening in the food and water dish 14; other attachment or connections configurations are also possible. The labeling 6 on container 4 comprises a logo 22 providing a brand name or other identifying information for the hydration system 2. The labeling 6 is configured to indicate that the beverage 12 within the container 4 does not meet FDA and EPA human safety standards, for example in this case by indicating that the beverage is “not for humans.” The labeling 6 also identifies an added flavorant configured to appeal substantially only to non-human animals, which in the embodiment depicted is beef flavor.

FIG. 2 depicts a carton 24 holding a plurality of hydration systems 2 which in the embodiment shown comprise re-sealable caps 26 so that the bottles of the hydration system 2 can be opened and re-closed as desired by a user. Carton 24 is one embodiment of packaging that can be used to contain, transport, convey or otherwise facilitate actions with the containers 4 that make up the hydration systems 2. (As used herein, “hydration system” indicates a system comprising at least a container and a beverage.) In carton 24, the hydration systems 2 are maintained in an upright position. In the embodiment depicted in FIG. 1, the hydration systems 2 are inverted to an upside-down position such that beverage 12 can flow via the action of gravity from container 4 to the beverage holding area 18 of food and water dish 14.

If desired, the food and water dish can be solely a water dish with a food holding portion, and may or may not include an incorporated bottle-juncture such as depicted in FIG. 1. In addition, the animal-friendly beverage supplier, i.e., the food and water dish 14 in FIG. 1, can be configured for animals that lap their water such as cats and dogs or can be in any other desired form appropriate for the particular animal such as an inverted bottle with a water dispensing tube suitable for rats, mice, guinea pigs, hamsters, gerbils, and other rodents; smaller size open dishes suitable for birds; and, large troughs or other dispensers suitable for use with pigs, goats, sheep, cattle, horses and other livestock and animals. In other words, the ultimate beverage supplier can be configured to any form desired for the given animal(s) desired to be drinking the beverage.

The labeling 6 and packaging 24 depicted in FIGS. 1 and 2 are exemplary of any kind of labeling/packaging desired to be used with the systems and methods herein. For example, the packaging or labeling can be directly affixed to the container, as in both FIGS. 1 and 2 or can be attached via a lanyard such as a string or a plastic leash, or can be maintained on a external container such as a box, palette, plastic wrap, etc., that is associated with otherwise marked or unmarked bottles. Indeed, the packaging or labeling can even be maintained on a website or other non-physically associated media provided that the correlation between the products, systems, methods, etc., herein and the packaging or labeling is clear. Accordingly, in some embodiments, the present invention comprises such labeling and/or packaging configured to convey the indicated elements even if such packaging or labeling is not actually physically attached to or adjacent to the actual systems or beverage containing containers.

Turning to some further discussion of various embodiments, in one embodiment, the systems comprise a hydration system configured for non-human animals wherein a container, preferably sealed, and further preferably re-sealable, contains the hydration beverage. The hydration beverage comprises surface water comprising trace elements of nutrients beneficial for on-human animals. “Surface water” indicates that the water has been obtained from a surface source. Indeed, in certain embodiments the hydration beverage is substantially only from such a surface source. Examples of such surface sources include glaciers, snowfields, creeks, streams, rivers, seeps, ditches, canals, open reservoirs, ponds, bays, bayous, swamps and bogs. Such sources can be contrasted from natural sources that have not provided an opportunity for the water to travel along the surface and collect the desired nutrients, such as spring water fresh at the source and borehole water. The surface water thus can comprise trace components that have been picked up on or from the surface such as colloidal minerals which, in some embodiments, is used to indicate that the colloidal minerals are natural and non-processed. Surface sources can also be distinguished from highly processed water (regardless of the initial source of such water), such as water that has been processed according to human standards to provide water that meets FDA and/or EPA human drinking water requirements (and/or other human standards in non-U.S. countries). For example, such “humanized” water may meet minimum contaminant levels (MCLs) for a plurality of different components found in unprocessed water whereas the surface water discussed herein would exceed at least one, and typically a plurality such as 2, 3, 5 10 or more, of such MCLs. Further, as noted above, the packaging and/or labeling may be specifically configured to indicate that the beverage associated therewith does not meet human safety standards.

The surface water contains trace elements in nutrients beneficial for non-human animals. Examples of such trace elements and nutrients include colloidal minerals and vitamins. In some embodiments, colloidal minerals and vitamins comprise at least 1, 2, 3, 5, 10 or more of vitamin B12, thiamine, riboflavin, niacin, pyridoxine HCL, pantothenic acid, choline, cholecalciferol and other vitamin Ds, d-alpha tocopheryl acetate and other vitamin E compounds such as tocopherol, tocotrienes and tocotrienols, silica, iron, zinc, cobalt, copper, manganese, magnesium, potassium, phosphorus, and carbon. The nutrients can also include vinegar or acetic acid and, in some embodiments, even healthful bacterial or other microorganisms such as beneficial coliforms.

Typically, the beverages discussed herein do not include preservatives or other non-nutritive components, although such may be added if desired in some embodiments. In preferred embodiments, the preservatives, etc., do not substantially harm or inhibit the beneficial effects of the other trace components, or indeed even the water itself, of the beverages.

The trace components in the beverages herein are not configured to be a sole source of such components. Rather, the beverages are configured to primarily provide hydration, with the trace components providing additional nutritive and beneficial effects for the animal, but such beverages do not contain adequate amounts of the various trace components to be a sole, or even, typically, a primary, source of such components. This is in contrast to vitamin or nutrient supplements that may be provided in an aqueous base but which contain such non-aqueous components in amounts sufficient to be a primary or sole source of the given components for the animal. In other words, in such embodiments, the beverages herein are configured primarily for hydration and not primarily for vitamin, protein, food, etc., provision for the animal.

In certain embodiments, as noted above, the hydration beverage comprises at least one added flavorant configured to appeal substantially only to non-human animals. Typically, the packaging or labeling is configured to identify the flavorant. Exemplary flavorants include meat flavorants such as beef, chicken, lamb, turkey, and fish, as well as non-meat flavorants such as plant flavorants such as chlorophyll, grass, lettuce as well as other flavorants such as apple cider, vinegar and milk lactose.

In some embodiments, the surface water or other water in the beverage comprises a pH of about 6.3 to 7.1 and further comprises at least colloidal minerals and vitamins as the trace components. The beverage can be configured to be color stable and bacteria logically stable for at least about one year in a sealed, i.e., unopened container, preferably without any added preservatives.

In some embodiments, the hydration beverage is purified using at least one of the following methods. The surface water can be produced by purifying the surface water with closed container (i.e., purified in a closed system within in/out ports to add or remove desired components) circulation through low-pressure ultraviolet/(UV) light, for example from about 200-300 nm, for example 253.7 nm at 0.005 kW to 0.028 kW, in a range from about mJ cm² to 253 mJ cm², for example from about 150-400 nm. Such energy may also be provided up to about 30 kW. The surface water can also be purified via closed container circulation with ozone (O₃) of about 2.4 0.5 to 2.4, 5 or 25 grams per U.S. gallon injection or by heating to a temperature from about 78° F. to about 212° F.

In some embodiments, the hydration composition configured for non-human animals comprises water, which may be other than surface water, and at least one added flavorant configured to appeal substantially only to non-human animals, as discussed elsewhere herein, and typically further comprising at least one of packaging and labeling associated with the composition and configured to specifically identify the added flavorant. The added flavorant can be added in any desired amount, for example from about 100-15,000 ppm (parts per million) of the composition, and the labeling or packaging can also be configured to indicate that the composition or beverage is not for humans.

In some embodiments, a coloring configured to appeal to a non-human animal can also be added. For example, the coloring may render the water cloudy or otherwise appealing to animals while non-appealing to humans, or can be a particularly animal-friendly color such as blood red, dirt brown, grass green, etc. In still other embodiments, non-natural colors that have added appeal to certain animals can also be provided, such as fluorescent colors.

In still further embodiments, methods of making, using, etc., the compositions herein are provided.

In some methods, a non-human animal can be hydrated by a) dispensing a hydration beverage configured for the non-human animal from a resealable container into a drinking vessel configured for drinking by the non-human animal, wherein the hydration beverage comprises surface water comprising trace elements and nutrients beneficial for the non-human animal, wherein at least one of packaging and labeling for the resealable container can be configured to indicate that the hydration beverage can be not for humans, and wherein the hydration beverage does not meet FDA and EPA human safety standards; and, b) allowing the non-human animal to drink from the drinking container. The hydration beverage can further comprise at least one added flavorant as discussed herein and the packaging and labeling can be configured to indicate the flavorant.

The surface water can be collected substantially only from at least one of a glacier, snowfield, creek, stream, river, seep, ditch, canal, open reservoir, pond, bay, bayou, swamp, and bog, and may comprise colloidal minerals and vitamins and a pH of about 6.3 to 7.1.

The surface water can be purified with at least one of closed container circulation through low pressure ultraviolet (UV) light in a range from about 19 mJ cm² to 253 mJ cm² from about 200 to 300 nanometers, closed container circulation with ozone (O₃) of about 0.5 to 25.0 grams per U.S. gallon injection, and heating to about 78° F. to about 212° F.

In further embodiments, the methods of hydrating a non-human animal can comprise a) dispensing a hydration composition configured for the non-human animal from a container into a drinking vessel configured for drinking by the non-human animal, the composition comprising water and at least one added flavorant configured to appeal substantially only to non-human animals, wherein at least one of packaging and labeling attached to the container can be configured to specifically identify the flavorant; and, b) allowing the non-human animal to drink from the drinking container. The methods can be performed with the beverage or composition dispensed from a resealable container, and hydration composition can consist essentially of surface water comprising trace elements and nutrients beneficial for non-human animals and a label configured to indicate that the composition is not for humans, for example because the contents do not meet FDA and EPA human safety standards.

The added flavorant can be a meat flavoring such as beef, chicken, lamb, turkey or fish or another flavoring such as chlorophyll, grass, or lettuce. The added flavorant can comprise about 1 to 100,000 ppm (parts per million) of the composition.

All terms used herein, including those specifically discussed above, are used in accordance with their ordinary meanings unless the context or definition clearly indicates otherwise. Also unless indicated otherwise, except within the claims, the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

The scope of the present systems and methods, etc., includes both means plus function and step plus function concepts. However, the terms set forth in this application are not to be interpreted in the claims as indicating a “means plus function” relationship unless the word “means” is specifically recited in a claim, and are to be interpreted in the claims as indicating a “means plus function” relationship where the word “means” is specifically recited in a claim. Similarly, the terms set forth in this application are not to be interpreted in method or process claims as indicating a “step plus function” relationship unless the word “step” is specifically recited in the claims, and are to be interpreted in the claims as indicating a “step plus function” relationship where the word “step” is specifically recited in a claim.

Other terms and phrases in this application are defined in accordance with the above definitions, and in other portions of this application.

From the foregoing, it will be appreciated that, although specific embodiments have been discussed herein for purposes of illustration, various modifications may be made without deviating from the spirit and scope of the disclosure. Accordingly, the systems and methods, etc., include such modifications as well as all permutations and combinations of the subject matter set forth herein and are not limited except as by the appended claims.

What is claimed is:

1. A hydration system configured for non-human animals, comprising a sealable container containing a hydration beverage comprising surface water comprising trace elements and nutrients beneficial for non-human animals and at least one of packaging and labeling configured to indicate that the beverage is not for humans, wherein the beverage does not meet FDA and EPA human safety standards.

2. The hydration system of claim 1 wherein the hydration beverage further comprises at least one added flavorant configured to appeal substantially only to non-human animals and the system comprises at least one of packaging and labeling configured to identify the flavorant.

3. The hydration system of claim 2 wherein the added flavorant is a meat flavoring.

4. The hydration system of claim 3 wherein the meat flavoring is at least one of beef, chicken, lamb, turkey and fish.

5. The hydration system of claim 2 wherein the added flavorant is at least one of chlorophyll, grass, lettuce, apple cider vinegar, and milk lactose.

6. The hydration system of claim 1 wherein the container is re-sealable.

7. The hydration system of claim 1 wherein the surface water is collected substantially only from at least one of a glacier, snowfield, creek, stream, river, seep, ditch, canal, open reservoir, pond, bay, bayou, swamp, and bog.

8. The hydration system of claim 1 wherein the surface water comprises a pH of about 6.3 to 7.1 and further comprises colloidal minerals and vitamins.

9. The hydration system of claim 8 wherein the colloidal minerals and vitamins comprise at least two of vitamin B12, thiamine, riboflavin, niacin, pyridoxine HCL, pantothenic acid, choline, cholecalciferol, d-alpha tocopheryl acetate, silica, iron, zinc, cobalt, copper, manganese, magnesium, potassium, phosphorus, and carbon.

10. The hydration system of claim 1 wherein the hydration beverage is configured to be color stable and bacteriologically stable for at least about one year in a sealed container.

11. The hydration system of claim 1 wherein at least the surface water has been produced by purifying the surface water with closed container circulation through low pressure ultraviolet (UV) light in a range from about 19 mJ cm² to 253 mJ cm², about 200 to 300 nanometers.

12. The hydration system of claim 1 wherein at least the surface water has been produced by purifying the surface water with closed container circulation with ozone (O₃) of about 0.5 to 25 grams per U.S. gallon injection.

13. The hydration system of claim 1 wherein at least the surface water has been purified by heating the surface water to a temperature from about 78° F. to about 212° F.

14. The hydration system of claim 1 wherein the surface water substantially is not spring water or borehole water.

15. A hydration beverage system comprising a container containing at least a beverage configured for non-human animals comprising water and at least one added flavorant configured to appeal substantially only to non-human animals, wherein at least one of packaging and labeling associated with the beverage is configured to specifically identify the flavorant.

16. The hydration composition of claim 15 wherein the container is a resealable container, and wherein the hydration composition consists essentially of surface water comprising trace elements and nutrients beneficial for non-human animals and a label configured to indicate that the beverage is not for humans, wherein the beverage does not meet FDA and EPA human safety standards.

17. The hydration composition of claim 15 wherein the added flavorant is a meat flavoring.

18. The hydration composition of claim 17 wherein the meat flavoring is at least one of beef, chicken, lamb, turkey and fish.

19. The hydration composition of claim 15 wherein the added flavorant is at least one of chlorophyll, grass, and lettuce.

20. The hydration composition of claim 16 wherein the surface water is collected substantially only from at least one of a glacier, snowfield, creek, stream, river, seep, ditch, canal, open reservoir, pond, bay, bayou, swamp, and bog.

21. The hydration composition of claim 20 wherein the surface water comprises a pH of about 6.3 to 7.1 and comprises colloidal minerals and vitamins.

22. The hydration composition of claim 21 wherein the colloidal minerals and vitamins comprise at least two of vitamin B12, thiamine, riboflavin, niacin, pyridoxine HCL, pantothenic acid, choline, cholecalciferol, silica, iron, zinc, cobalt, copper, manganese, magnesium, potassium, phosphorus, carbon, and vinegar.

23. The hydration composition of claim 15 wherein the hydration beverage is configured to be color stable and bacteriologically stable for at least about one year in a sealed container.

24. The hydration system of claim 16 wherein at least the surface water has been produced by purifying the surface water with closed container circulation through low pressure ultraviolet (UV) light in a range from about 19 mJ cm² to 253 mJ cm², about 200 to 300 nanometers.

25. The hydration system of claim 16 wherein at least the surface water has been produced by purifying the surface water with closed container circulation with ozone (O₃) of about 0.5 to 25 grams per U.S. gallon injection.

26. The hydration system of claim 16 at least the surface water has been purified by heating the surface water to a temperature from about 78° F. to about 212° F.

27. The hydration system of claim 15 wherein the added flavorant comprises about 100 to 15,000 ppm (parts per million) of the composition.

28. A hydration system configured for non-human animals, comprising a resealable container containing a hydration beverage comprising surface water comprising trace elements and nutrients beneficial for non-human animals, wherein the surface water has been produced by purifying the surface water with closed container circulation through low pressure ultraviolet (UV) light in a range from about 19 mJ cm² to 253 mJ cm², about 200 to 300 nanometers, and wherein the surface water does not meet FDA and EPA human safety standards, and wherein at least one of packaging and labeling attached to the container is configured to indicate that the beverage is not for humans.

29. The hydration system of claim 28 wherein the hydration beverage further comprises at least one added flavorant configured to appeal substantially only to non-human animals, and wherein at least one of packaging and labeling attached to the container is configured to specifically identify the flavorant.

30. The hydration system of claim 29 wherein the meat flavoring is at least one of beef, chicken, lamb, turkey, fish, chlorophyll, grass, and lettuce.

31. The hydration system of claim 28 wherein the surface water is collected substantially only from at least one of a glacier, snowfield, creek, stream, river, seep, ditch, canal, open reservoir, pond, bay, bayou, swamp, and bog.

32. The hydration system of claim 28 wherein the surface water comprises a pH of about 6.3 to 7.1 and comprises colloidal minerals and vitamins.

33. The hydration system of claim 28 wherein the hydration beverage is configured to be color stable and bacteriologically stable for at least about one year in a sealed container.

34. The hydration system of claim 28 wherein at least the surface water has been produced by purifying the surface water with closed container circulation with ozone (O₃) of about 0.5 to 25 grams per U.S. gallon injection.

35. The hydration system of claim 28 wherein at least the surface water has been purified by heating the surface water to a temperature from about 78° F. to about 212° F.

36. A hydration system configured for non-human animals, comprising a sealable container containing a hydration beverage comprising surface water comprising trace elements and nutrients beneficial for non-human animals, wherein the surface water has been produced by purifying the surface water with closed container circulation with ozone (O₃) of about 0.5 to 25 grams per U.S. gallon injection, and wherein the surface water does not meet FDA and EPA human safety standards, and wherein at least one of packaging and labeling attached to the container is configured to indicate that the beverage is not for humans.

37. The hydration system of claim 36 wherein the hydration beverage further comprises at least one added flavorant configured to appeal substantially only to non-human animals, and wherein at least one of packaging and labeling attached to the container is configured to specifically identify the flavorant.

38. The hydration system of claim 37 wherein the meat flavoring is at least one of beef, chicken, lamb, turkey, fish, chlorophyll, grass, and lettuce.

39. The hydration system of claim 36 wherein the surface water is collected substantially only from at least one of a glacier, snowfield, creek, stream, river, seep, ditch, canal, open reservoir, pond, bay, bayou, swamp, and bog.

40. The hydration system of claim 36 wherein the surface water comprises a pH of about 6.3 to 7.1 and comprises colloidal minerals and vitamins.

41. The hydration system of claim 36 wherein the hydration beverage is configured to be color stable and bacteriologically stable for at least about one year in a sealed container.

42. The hydration system of claim 36 wherein at least the surface water has been produced by purifying the surface water with closed container circulation through low pressure ultraviolet (UV) light in a range from about 19 mJ cm² to 253 mJ cm², about 200 to 300 nanometers.

43. The hydration system of claim 36 wherein at least the surface water has been purified by heating the surface water to a temperature from about 78° F. to about 212° F.

44. A hydration system configured for non-human animals, comprising a sealable container containing a hydration beverage comprising surface water comprising trace elements and nutrients beneficial for non-human animals, wherein the surface water has been purified by heating the surface water to a temperature from about 78° F. to about 212° F., and wherein the surface water does not meet FDA and EPA human safety standards, and wherein at least one of packaging and labeling attached to the container is configured to indicate that the beverage is not for humans.

45. The hydration system of claim 44 wherein the hydration beverage further comprises at least one added flavorant configured to appeal substantially only to non-human animals, and wherein at least one of packaging and labeling attached to the container is configured to specifically identify the flavorant.

46. The hydration system of claim 45 wherein the meat flavoring is at least one of beef, chicken, lamb, turkey, fish, chlorophyll, grass, and lettuce.

47. The hydration system of claim 44 wherein the surface water is collected substantially only from at least one of a glacier, snowfield, creek, stream, river, seep, ditch, canal, open reservoir, pond, bay, bayou, swamp, and bog.

48. The hydration system of claim 44 wherein the surface water comprises a pH of about 6.3 to 7.1 and comprises colloidal minerals and vitamins.

49. The hydration system of claim 44 wherein the hydration beverage is configured to be color stable and bacteriologically stable for at least about one year in a sealed container.

50. The hydration system of claim 44 wherein at least the surface water has been produced by purifying the surface water with closed container circulation through low pressure ultraviolet (UV) light in a range from about 19 mJ cm² to 253 mJ cm², about 200 to 300 nanometers.

51. The hydration system of claim 44 wherein at least the surface water has been produced by purifying the surface water with closed container circulation with ozone (O₃) of about 0.5 to 25 grams per U.S. gallon injection.

52. A method of hydrating a non-human animal comprising:
a) dispensing a hydration beverage configured for the non-human animal from a resealable container into a drinking vessel configured for drinking by the non-human animal, wherein the hydration beverage comprises surface water comprising trace elements and nutrients beneficial for the non-human animal, wherein at least one of packaging and labeling for the resealable container is configured to indicate that the hydration beverage is not for humans, and wherein the hydration beverage does not meet FDA and EPA human safety standards; and,
b) allowing the non-human animal to drink from the drinking container.

53. The method of claim 52 wherein the hydration beverage further comprises at least one added flavorant configured to appeal substantially only to non-human animals and the at least one of packaging and labeling is configured to indicate the presence of the flavorant.

54. The method of claim 53 wherein the meat flavoring is at least one of beef, chicken, lamb, turkey, fish, chlorophyll, grass, and lettuce.

55. The method of claim 52 wherein the surface water is collected substantially only from at least one of a glacier, snowfield, creek, stream, river, seep, ditch, canal, open reservoir, pond, bay, bayou, swamp, and bog.

56. The method of claim 52 wherein the surface water comprises a pH of about 6.3 to 7.1 and further comprises colloidal minerals and vitamins.

57. The method of claim 56 wherein the colloidal minerals and vitamins comprise at least two of vitamin B12, thiamine, riboflavin, niacin, pyridoxine HCL, pantothenic acid, choline, cholecalciferol, d-alpha tocopheryl acetate, silica, iron, zinc, cobalt, copper, manganese, magnesium, potassium, phosphorus, carbon, and vinegar.

58. The method of claim 52 wherein at least the surface water has been produced by purifying the surface water with closed container circulation through low pressure ultraviolet (UV) light in a range from about 19 mJ cm² to 253 mJ cm², about 200 to 300 nanometers.

59. The method of claim 52 wherein at least the surface water has been produced by purifying the surface water with closed container circulation with ozone (O₃) of about 0.5 to 25 grams per U.S. gallon injection.

60. The method of claim 52 wherein at least the surface water has been purified by heating the surface water to a temperature from about 78° F. to about 212° F.

61. The method of claim 52 wherein the surface water substantially is not spring water or borehole water.

62. A method of hydrating a non-human animal comprising:
a) dispensing a hydration composition configured for the non-human animal from a container into a drinking vessel configured for drinking by the non-human animal, the composition comprising water and at least one added flavorant configured to appeal substantially only to non-human animals, wherein at least one of packaging and labeling attached to the container is configured to specifically identify the flavorant; and,
b) allowing the non-human animal to drink from the drinking container.

63. The method of claim 62 wherein the composition is dispensed from a resealable container, and wherein the hydration composition consists essentially of surface water comprising trace elements and nutrients beneficial for non-human animals and a label configured to indicate that the composition is not for humans, wherein the contents do not meet FDA and EPA human safety standards.

64. The method of claim 62 wherein the added flavorant is a meat flavoring.

65. The method of claim 64 wherein the meat flavoring is at least one of beef, chicken, lamb, turkey and fish.

66. The method of claim 62 wherein the added flavorant is at least one of chlorophyll, grass, and lettuce.

67. The method of claim 66 wherein the surface water comprises a pH of about 6.3 to 7.1 and comprises colloidal minerals and vitamins.

68. The method of claim 62 wherein the hydration beverage is configured to be color stable and bacteriologically stable for at least about one year in a sealed container.

69. The method of claim 62 wherein the added flavorant comprises about 100-15,000 ppm of the composition.
